(19) United States
(12) Patent Application Publication
(10) Pub. No.: US 2019/0179366 A1
(43) Pub. Date: Jun. 13, 2019

(54) Laptop Surface Enhancer

(71) Applicant: Harrison Ferber, New York, NY (US)

(72) Inventor: Harrison Ferber, New York, NY (US)

(21) Appl. No.: 16/192,502

(22) Filed: Nov. 15, 2018

Related U.S. Application Data
(60) Provisional application No. 62/586,704, filed on Nov. 15, 2017.

(51) Int. Cl. G06F 1/16; G06F 3/039

(52) U.S. Cl. CPC G06F 1/1607; G06F 1/1616; G06F 3/039

(57) ABSTRACT

The present invention is an apparatus that reduces repetitive strain while using a laptop computer. The invention covers high use areas on the device where the user comes into contact with the surface of the device, and alters the surface of the device to make it more comfortable, without replacing standard device hardware. The invention can also utilize a unique, user friendly universal sizing system that allows for the invention to be used on multiple device shapes and sizes, thus allowing for optimal coverage on the surface of the device regardless of device model variation. Additionally, the invention features unique specific shapes and sizes that have been engineered to fit specific device models. This invention features multiple features to improve user comfort and reduce injury, while also maintaining a practical and user friendly design that does not limit the function of the device.

### CROSS REFERENCE TO RELATED APPLICATION

This application claims the benefit of priority from, and hereby incorporates by reference, U.S. Provisional Patent Application Ser. No. 62/586,704, filed Nov. 15, 2017, entitled “Method for altering the surface of a device without removing the device?s hard-ware.”

### FIELD OF INVENTION

The present invention relates to an apparatus that makes the surface of a laptop computer more comfortable and more safe to use. The present invention changes the surface of a device to help improve grip, eliminate bacteria, offer support, reduce sweat, alter texture, change the appearance, decorate, provide cushioning, or other alterations to the surface of a device, without removing any current hardware on the device surface or hampering the device's functionality.

### BACKGROUND OF THE INVENTION

Facing daily use, drops, and knocks, laptops need to be built tough. Yet by designing such durable devices, surfaces are hard or rubbery. These materials are great for protecting the fragile electronics encased inside of the laptops shell, but not so fun to hold or rub against, especially during constant usage. A graphic designer can spend hours clicking a trackpad and a student may be up all night typing on her laptop, with their wrists glued to the surface of their laptop. Yet, these surfaces are not well suited for extended contact by humans. While the device's surface is built to withstand regular wear, we are not. That is why I invented the present invention. At its most simple, it utilizes a material, either natural or synthetic, to act as a barrier between body and device without detracting from the device.

The present invention utilizes many features that separate it from prior art. The present invention uses a specifically engineered shape or series of shapes that can fit a wide variety of laptop models that may differ in size or shape. These different laptop sizes require a tailored fit not seen in prior art, which at best take a one size fits all approach. The present invention also uses a structure that is thick enough to cushion the user while thin enough to allow for a laptop computer to shut properly. The present invention differs from a protective laptop case or sleeve in that the apparatus is designed to protect the user, not the device, and thus takes a completely different form with a range of different compositions. The present invention has a singular and unique function, to provide your body with a more comfortable point of contact. Computer usage can cause serious injuries that affect millions of people worldwide, especially patients with wrist tendonitis, arthritis, or sensitive skin conditions. The present invention provides these people the comfort and freedom to use the world's most powerful tool, the computer.

Currently there are numerous decals or stickers that cover the surface of all variety of laptops. Yet, these decals do nothing more than alter the appearance of the device. Decals are commonly made with vinyl, a material that may irritate some users as vinyl often contains chlorine, lead, and other toxic substances. These toxic additives easily leach, and merely handling a vinyl surface can result in lead exposure. Vinyl can also create toxic off-gas, which the user will inhale, especially during the continued use of a device which creates significant friction on the vinyl's surface. Vinyl has been linked to cancer, asthma, and other serious conditions. A decal alters the surface of a laptop computer in a method that is against the core principal of the present invention in that it does not make the device more comfortable or safer. Thus, there is a need for an apparatus that provides the tailored coverage of a decal and a safe, comfortable surface on which to rest a weary wrist.

Also available are traditional device wrist rests. These traditional devices do not cover multiple laptop sizes and use a one size fits all device to partially cover some laptops. Further, traditional devices are too thick to stay on the laptop during transit, and thus must be removed in order for the laptop's screen to close properly. No current decal nor traditional wrist rest covers a range of device shapes and sizes, while also allowing for the user to shut their laptop screen, all while providing benefit to users via enhancing the surface of a laptop. Further, the present invention has also discovered a unique multi shape system for covering multiple device shapes and sizes by applying multiple different shapes to a single device to offer customizable coverage depending on the device's size. No current traditional wrist rest uses customized shapes to cover specific device models.

The present invention combines the surface area coverage of a decal, with the comfort of a device cushion. When covering a $1000 laptop, users demand tailored coverage. Further, users do not want an apparatus that makes their portable device more difficult to use. A laptop's mission is to be portable. Instead, the prior art adds another accessory for the user to carry. This comfort device now becomes a hindrance. Never before has a surface enhancement apparatus been designed to provide an accurate fit on a device's wrist rest, while also allowing for easy transport by fitting between screen and keyboard when stowed.

### BRIEF SUMMARY OF THE INVENTION

The present invention is a specifically shaped, sized, or engineered laptop surface enhancement apparatus, that can be a single layer, or a unit comprised of multiple layers. The apparatus can be affixed to the surface of a device which will alter the surface of the device to benefit the human body, without replacing the stock hardware of the device. The invention can be a singular shape or part of a multi-shape system that can use multiple shapes to customize the size of the apparatus depending on the size of the device.

The present invention is carefully engineered with respect to the functionality of a device, ensuring that it does not completely obstruct the devices functions, from portability to clicking the trackpad. The present invention can be made with myriad combinations of material, as outlined in the drawings and detailed description.

The present invention's shape can be tailored to a singular specific device model.

The present invention can be constructed using multiple separate shapes as part of a multi shape system. The system features ancillary pieces on the same release liner that can be used to fill in size differences across different device models when the shapes are used together.

This invention can also be printed more than one color.

This combination of tailored sizing, retained device function, improved user comfort, and improved user wellbeing is unique to primary and peripheral devices and to currently existing products.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Primary object of the present invention is to provide a laptop surface enhancing system that will overcome the shortcomings of the prior art devices.

A second object is to provide a device surface enhancing system that does not remove any stock hardware.

Another object is to not impede the device's functionality.

Another object is that the system does not need to be removed during use or storage of the device.

Another object is to provide a surface that is better suited to the human body than the stock device surface. For example, making the surface softer or cushioned.

Another object is to enhance over 75% of the surface area of one wrist rest on a specific laptop device model using a single shape.

Another object is to use a multi shape system to offer users a customizable shape in order to better fit a wider range of devices models.

Another object is to use a system that uses different multi shape systems to provide further customization to the user.

Another object is to utilize an adhesive or gripping treatment or an inherently adhesive material to allow for the invention to remain on the device.

Another object is to reduce the fatigue in the user.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

This summary is provided to introduce concepts in simplified form that are further described below in the Detailed Description. The Brief Summary is not intended to identify essential features of the disclosed or claimed subject matter, and is not intended to describe each disclosed embodiment or every implementation of the disclosed or claimed subject matter, and is not intended to be used as an aid in determining the scope of the claimed subject matter.

### BRIEF DESCRIPTION OF THE DRAWINGS

Many aspects of the present disclosure can be better understood with reference to the following drawings. The components in the drawings may not necessarily be to scale, with attention instead being placed upon clearly demonstrating the principles of the disclosure. Moreover, in the following drawings, like reference numerals designate corresponding parts throughout the several depictions.

FIG. 1 is a drawing of the area on a laptop computer defined as a wrist rest (100) the left boundary (101) the right boundary (102) the lower edge boundary (103) and the upper edge boundary (104)

FIG. 2 is a drawing of a single shape apparatus from the front perspective (200).

FIG. 3 is a drawing of an overhead perspective of a laptop computer (300) with an apparatus on the left (201) and an apparatus on the right (302) illustrated in a position that best depicts the present invention.

FIG. 4 is a drawing of a side perspective of a closed laptop computer screen (400) with the apparatus between the screen (401) and the keyboard area of the laptop below (402) illustrated in a position that best depicts the present invention.

FIG. 5 is an exploded perspective of a multilayered apparatus illustrating the surface layer (500), the benefit layer (501), and the adhesive layer (502).

FIG. 6 is a drawing of a multilayered apparatus illustrating the surface (600) layer, the benefit layer (601), and the adhesive layer (602).

FIG. 7 is a drawing of a multi shape apparatus from a front perspective (700) the base shape of the apparatus (701) a first ancillary shape (702) a second ancillary shape (703) and a release liner on which the shapes are contained (704).

FIG. 8 is a drawing of an above perspective of a laptop computer (800) with an ancillary shape on the left (801) a base shape on the left (802) another similar base shape on the right (803) and another similar ancillary shape on the right (804).

FIG. 9 is a drawing of a larger system that uses different multi shape systems depicting a 2 multi shape systems, with one on the left (900) and another on the right (901).

FIG. 10 is a drawing of an apparatus that uses a textured surface with bumps and ridges on the left (1001) and right (1002) wrist rest area of the laptop (1000).

FIG. 11 is a drawing from the front of an unapplied apparatus that uses one single shape (1100) to enhance both wrist rest areas on a particular laptop model. The shape uses a window (1104) between the left side of the apparatus (1101) the right side of the apparatus (1102) and below the bridge (1103) that connects the left side to the right side. This embodiment shows one example of a single shaped apparatus that can enhance the surface of multiple laptop wrist rests with a single shape.

FIG. 12 is an overhead perspective of an applied apparatus that uses one single shape (1200) to enhance both wrist rest areas on a particular laptop model. The shape uses a window (1204) that allows for the user to interact with the trackpad.

While the above-identified figures set forth one or more embodiments of the disclosed subject matter, other embodiments can also be created although not explicitly mentioned here. This disclosure presents the disclosed subject matter by way of representation and not limitation.

It should be understood that numerous other modifications and embodiments can be devised by those skilled in the art which fall within the scope and spirit of the principles of this disclosure.

The figures may not be drawn to scale. Moreover, where terms such as above, below, over, under, top, bottom, side, right, left, etc., are used, it is to be understood that they are used only for ease of understanding the description. It is contemplated that structures may be otherwise oriented.

### DETAILED DESCRIPTION OF THE INVENTION

This disclosure relates to a laptop wrist rest enhancing apparatus that features a unique size and shape to provide a customized fit for specific laptop computer models. The apparatus can use multiple layers to provide additional benefits to the user, such as a cooling sensation, shock absorption, or bacteria reduction, as well as many other benefits. The apparatus can also utilize a unique multi-shape system that adapts the size of a base shape depending on the size of the intended laptop by adding additional shapes to the laptop's surface. The apparatus can also use a single shape configuration that can cover both wrist rests on a laptop.

The laptop wrist rest enhancing apparatus of this disclosure is a new invention that has not previously been available to the public with the ability to fit multiple device models in this manner with these new benefits. The computer is one of the most frequently used tools, with many people interacting with a computer for most of their waking hours. Due to the tremendous amount of time spent operating a computer, repetitive stress injuries can and do occur. There is a public health need for such an invention that can adequately cover a laptop's wrist rest area without being obtrusive or unattractive. The following figures are described in detail to help provide clarity on the present invention's concept and structure.

Disclosed is an apparatus for enhancing the surface of a laptop computer's wrist rest. This apparatus has multiple embodiments that vary in construction and components. In the following detailed description, a general description of the apparatus and its components is provided.

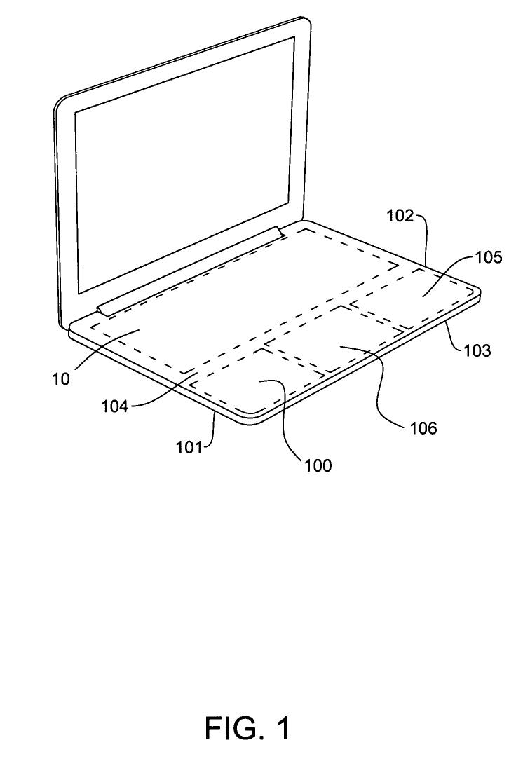

FIG. 1 is a drawing of the area on a laptop computer defined as a wrist rest (100) and (105) the track pad (106) the left boundary (101) the right boundary (102) the lower edge boundary (103) and the upper edge boundary (104). This drawing defines the wrist rest area and helps to depict the area that the apparatus covers.

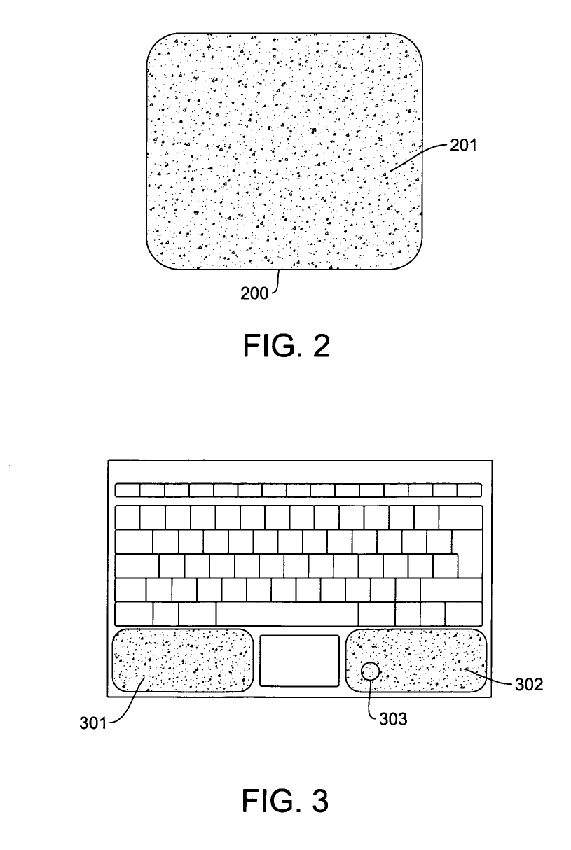

FIG. 2 is a drawing of a single shape apparatus from the front perspective (200) that is not affixed to a laptop computer. The apparatus depicted in this embodiment is designed to cover a Mid 2015 Macbook Pro Retina laptop computer. This embodiment uses a thickness of 1.00 mm so that the Mid 2015 Macbook Pro Retina can close its screen when desired. The apparatus uses a length of 4.00 inches and a width of 3.50 inches to provide the specific laptop model's wrist rest area coverage and surface alteration. Other laptop computers can be manufactured and the apparatus can be made in differing shapes and sizes to alter the surface of differing laptop device models. Examples of different laptop device models are the HP Envy, Macbook Pro, Macbook, Dell Inspiron 14 3000, Lenovo Ideapad 320, Chromebook 3180, Samsung Chromebook 3, and multiple other laptop models that will occur to those of skill in the art. The embodiment's surface layer comprises soft microfiber material (201) that improves the comfort of the user, reduces skin irritation during use, as well as many other benefits. The composition of and the material used in the surface layer is one of many that provide similar benefits, though many other compositions and materials are available and will not depart from the spirit of the disclosure.

FIG. 3 depicts an overhead perspective of a Mid 2015 Macbook Pro Retina laptop computer (300) with an apparatus on the left (301) and an apparatus on the right (302) and the laptop's trackpad in between the two apparatus. This depiction demonstrates the ability for the apparatus to cover greater than 75% of a single wrist rest area on a specific laptop computer model. This specification is significant because no other current product offering attempts to cover specific device models adequately. Instead prior art attempts to use a one size fits all approach that does not work effectively on many laptop computers. The image also depicts the ability of the apparatus to provide a specific laptop device model customized wrist rest area coverage. Also depicted in the embodiment on both the left apparatus (301) and the right apparatus (302) is the surface layer (303). The surface layer provides cushioning to the users wrist. The surface layer also reduces irritation to the users skin. Other surface layer constructions and compositions that are not mentioned can also be used, and thus can provide other benefits.

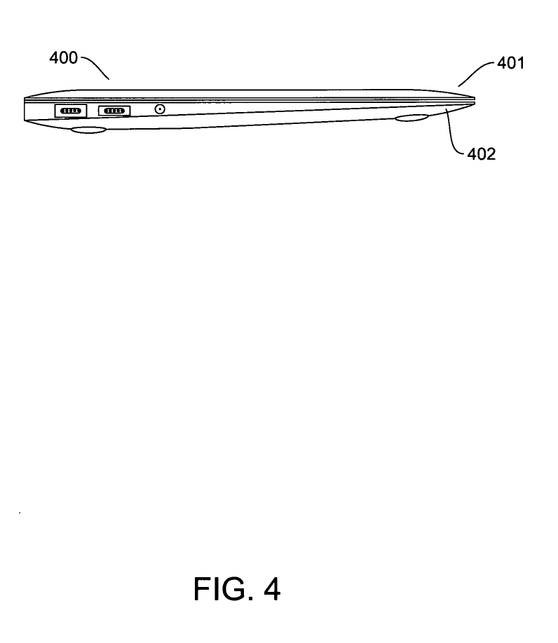

FIG. 4 is a side perspective of a Mid 2015 Macbook Pro Retina (400) with the apparatus displayed between the closed laptop screen (401) and the keyboard area of the laptop at the bottom (402). This depiction demonstrates the ability of the apparatus to allow for the laptop to close its screen for storage, without the apparatus needing to be removed from the device after use. The embodiment uses an apparatus thickness of 1.00 mm, so that the device can fit between the screen and the keyboard area. The thickness described by the embodiment is just an example so as to further illustrate the concept herein. Any number of thickness measurements can be used for the apparatus that will occur to those of skill in the art.

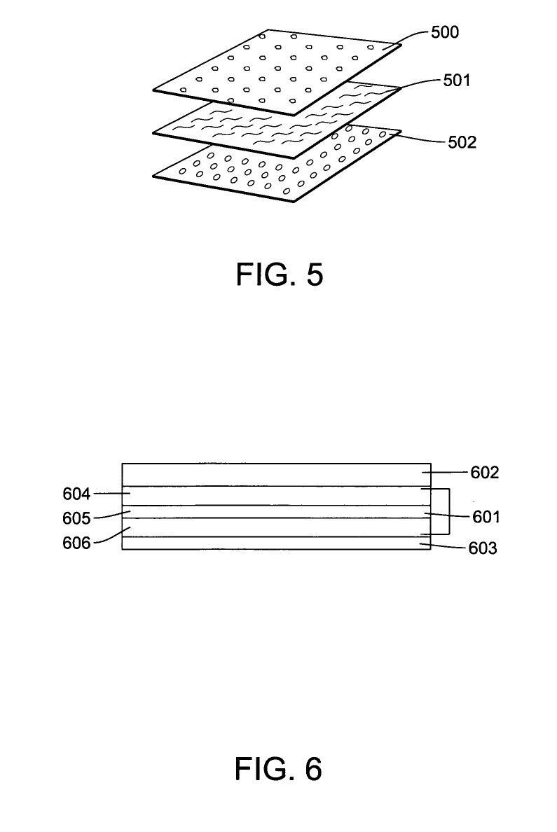

FIG. 5 is an exploded perspective of a multilayered apparatus illustrating the surface layer (500), the benefit layer (501), and the adhesive layer (502). Each layer has a specific function in the apparatus, and each layer provides the user with a different advantage.

The surface layer (500) is the layer that most frequently comes into contact with the skin of the user. This layer is also the most visible layer of the apparatus and thus may be printed with a graphic or color for decoration. The embodiment depicted uses a fabric material to provide the user with a softer surface, rather than the hard aluminum body of the Mid 2015 Macbook Pro. This embodiment can also provide additional cushioning to the apparatus and thus the user. The surface layer can provide a variety of different benefits to the user, such as wicking moisture, reducing bacteria, and multiple other surface benefits that will occur to those of skill in the art. The surface layer can also be comprised of many different types of materials, and even combinations of different materials, that differ from the embodiment described.

The benefit layer (501) is the layer or series of layers between the surface layer (500) and the adhesive layer (502). In this embodiment, the benefit layer is comprised of a rubber substrate that provides comfort, shock absorption, and stability to the body of the user. Other materials and compositions can be used in the benefit layer to provide other benefits to the user. In other embodiments the benefit layer can utilize multiple materials or layers to provide many other benefits to the user. Laptop computer users often spend long periods of time applying force to their hand and wrist. Thus, it is an improvement to the standard surface of laptop computers to add a comfort layer to help reduce injury risk through repeat stress and also reduce general user fatigue.

The adhesive layer (502) is the layer that comes into contact with the stock hardware surface of the laptop computer, and affixes the apparatus to the device. This layer enables the apparatus to enhance the surface of the device by effectively covering it, which allows for the surface of the device to be enhanced without replacing the standard hardware. The adhesive layer is securely attached to the benefit layer, but maintains removability on the surface of the device. The present invention preserves the integrity of the multi layer composition while also allows for the apparatus to be removed from the device. The adhesive layer can be comprised of a variety of different types of adhesive tape or other method of affixing the apparatus as will occur to those of skill in the art.

FIG. 6 is a side perspective of an embodiment that utilizes a benefit layer (601) that has multiple layers and materials rather than a singular layer and material. This embodiment demonstrates that the benefit layer can utilize multiple materials for different benefits. This embodiment uses a cooling gel (604), as well as a rubber (605) and (606) for added cushioning. This concept is not limited to the composition of the embodiment and can be applied to multiple materials and combinations of materials as will occur to those of skill in the art. This embodiment also depicts a surface layer (602) and an adhesive layer (603).

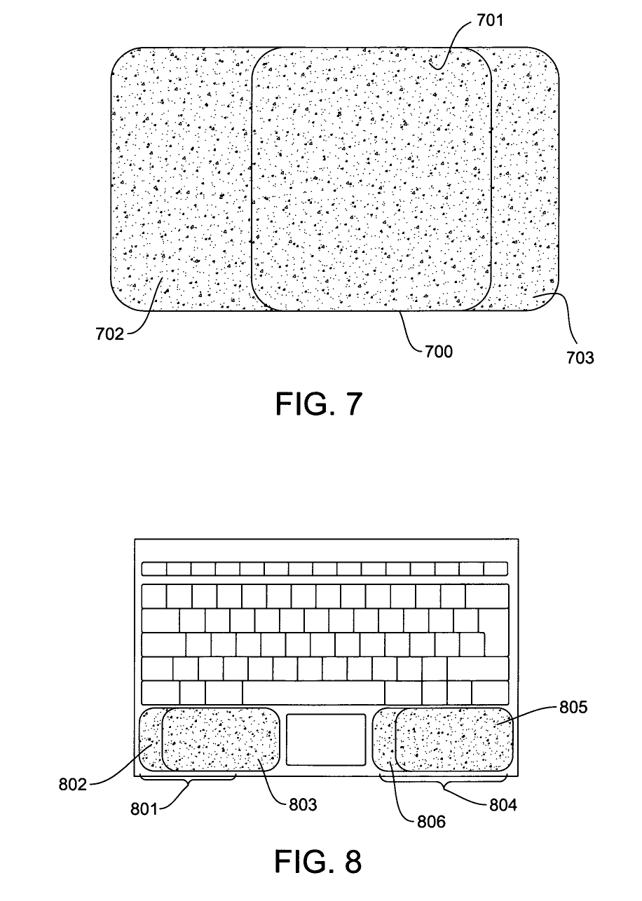

FIG. 7 is a drawing of a multi shape apparatus from the front perspective (700) that is not affixed to a laptop computer. The apparatus depicted in this embodiment is designed to cover multiple devices using either only the base shape (701) and the left ancillary shape (702), the base shape and the right ancillary shape (703), or all three shapes together. The user would evaluate how many shapes and which shapes to use to best cover the intended device's wrist rest area. Further, the base shape is designed to fit a laptop model on its own, and is specifically configured to fit a laptop as well. This customizable fit is a unique invention. The configuration of this embodiment and features herein do not limit the present invention to this specific configuration. This multi shape apparatus can take various sizes, use multiple other shape configurations or shape quantities, as will occur to those of skill in the art. This embodiment uses the same release liner to contain multiple shapes. The benefit of this configuration is that the user can use the multi shape unit as a guide to help define exactly how many shapes they wish to use. Also useful is the inherent stick that the shapes have to each other and thus two shapes can be applied together, which limits the amount of space in between each shape upon application and allows for a better fit and easier application process. The ancillary shape has a similar measurement to at least one side of the base shape. The embodiment depicts an ancillary shape that has a similar width to the base shape, although they do not have similar lengths. The ancillary shape can thus be positioned next to the base shape and maintain a similar total apparatus width. This feature allows for a better fitting apparatus and is a unique invention. The ancillary shape can have either a similar length or width to the length or width of the base shape, with a similar measurement being defined as within 0.50 inches of the base shape's measurement.

HG 8 depicts an overhead perspective of a Mid 2015 Macbook Pro Retina laptop computer (800) with an apparatus on the left (801) that uses an ancillary shape (802) and a base shape (803) and an apparatus on the right (804) that uses a similar base shape (805) and a similar ancillary shape (806). This depiction demonstrates the ability for the apparatus to cover greater than 75% of a single wrist rest area on a specific laptop computer model, while using a combination of shapes. The image also depicts the ability of the apparatus to provide a specific laptop device model customized wrist rest area coverage using a combination of specific shapes.

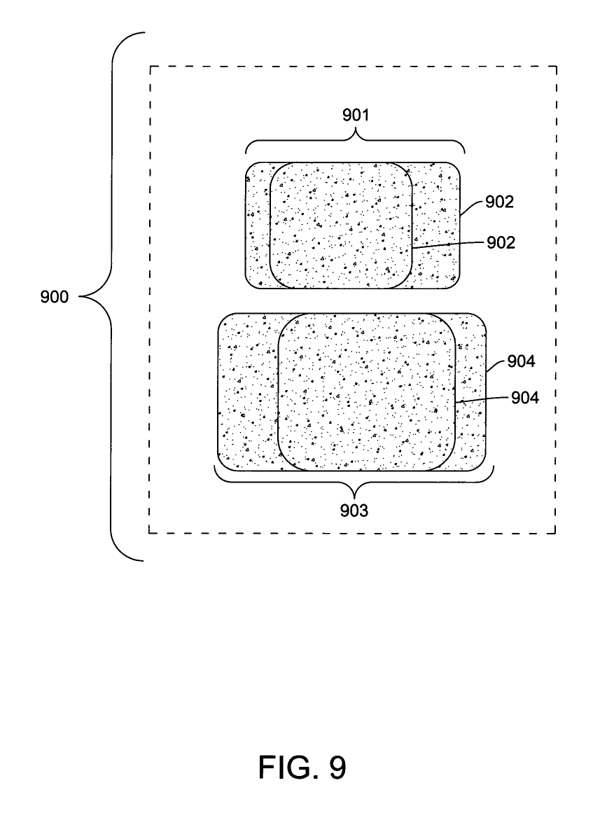

FIG. 9 depicts a larger system (900) that uses different multi shape apparatuses to provide greater coverage customization to the user. In this embodiment there is one multi shape apparatus (801) that uses three different size shapes that all share a similar width (902). There is also an additional multi shape apparatus (903) that uses three different shapes that also share a similar width (904), yet this width is greater than the width of the other multi shape apparatus. This greater width is significant because when paired together, these two multi shape apparatus can cover a larger variety of laptops. The narrower apparatus would be able to cover narrower wrist rest areas that the wider apparatus would be too large to cover as it would spill outside the boundary of the wrist rest and could possibly interfere with the functionality of the laptop's keyboard. The wider apparatus would be able to cover wider wrist rest areas that the narrower apparatus could not cover due to the amount of empty space left on the mist rest. If a user is not sure what theft laptop's wrist rest area size is, they would be able to hedge and have an alternative if the apparatus is too small or too large. This flexibility allows for the user to confidently use the apparatus without having to know the exact measurements of their laptop before purchase, a feature that is unique. This embodiment is an example of the concept described, and can have many variations in size, construction, composition, shape, quantity of apparatus, and quantity of shapes as will occur to those of skill in the art.

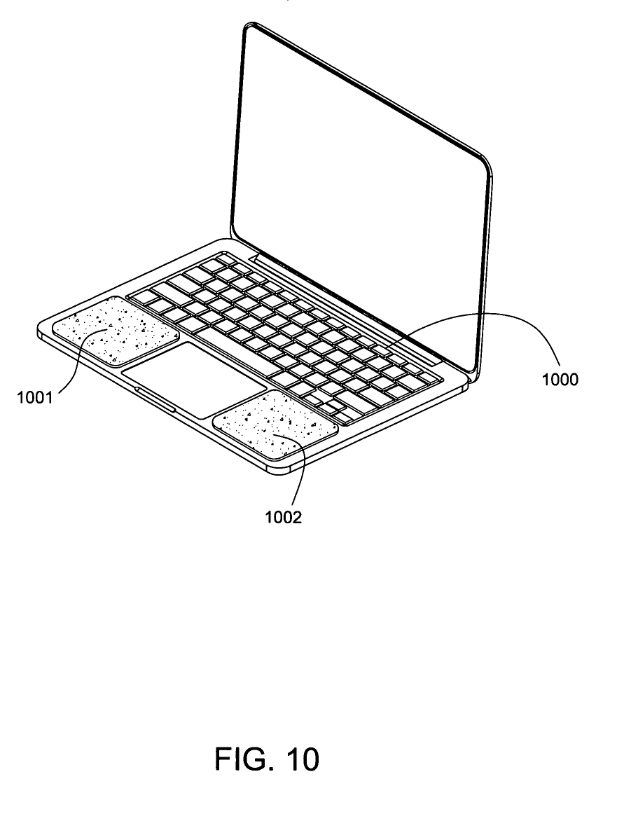

FIG. 10 depicts a perspective of a Mid 2015 Macbook Pro Retina laptop computer (1000) with an apparatus on the left (1001) and right (1002) wrist rest area that uses a textured surface with ridges and bumps to provide a therapeutic texture for the user. This embodiment is just an example and many other textures and formations can be used to provide similar therapeutic benefit to the user as will occur to those of skill in the art.

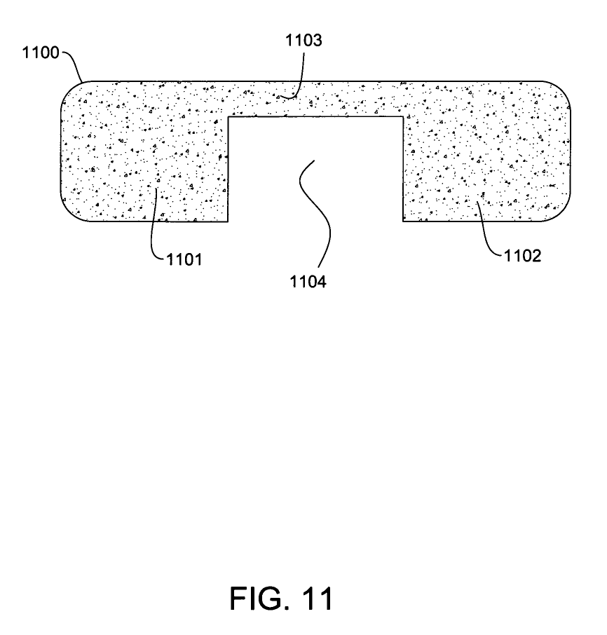

FIG. 11 depicts an embodiment of the present invention that allows for a single shape (1100) to enhance both wrist rest areas, rather than one shape on each wrist rest area, or even multiple smaller shapes on a single wrist rest area. This embodiment demonstrates an unapplied apparatus configured with a window with which the user can interact with the device's track pad. The window (1104) is positioned between the left side of the apparatus (1101) the right side of the apparatus (1102) and below the bridge (1103) that connects the left side to the right side. This single shaped apparatus can take on numerous shape and size configurations depending on the specifications of a specific laptop model. The embodiment described herein is only an example to demonstrate the concept described, and the present invention can have many variations in size, construction, composition, shape, quantity of apparatus, and other iterations as will occur to those of skill in the art. This single shape apparatus has not been seen in prior art and is a unique invention with benefits ranging from greater surface area coverage to easier application. This single shape device would also be thin enough to fit between the screen of the laptop when closed.

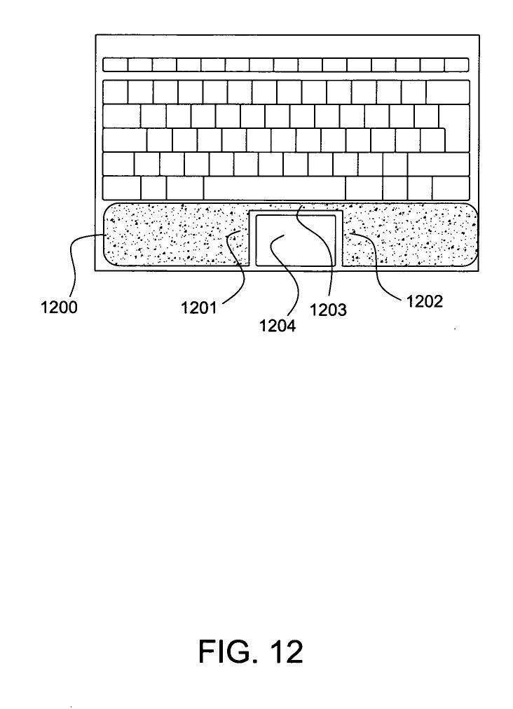

FIG. 12 is an overhead perspective of an apparatus that uses one single shape (1200) to enhance both wrist rest surfaces applied to a Mid 2015 Macbook Pro Retina. The shape uses a window (1204) that allows for the user to interact with the trackpad. The embodiment described herein is only an example to demonstrate the concept described, and the person invention can have many variations in size, construction, composition, shape, quantity of apparatus, and other iterations as will occur to those of skill in the art.

It should be emphasized that the above-described embodiments of the present disclosure are merely examples set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. An apparatus for enhancing the surface of a laptop computer's wrist rest without removing the laptop computer's standard hardware comprising:
a surface layer, wherein the surface layer comprises of material that provides a different tactile feeling than the standard surface on the user's laptop computer and can, but does not need to be, decorated with artwork or colors if desired
wherein the surface layer can be comprised of, but is not limited to, natural fabrics, synthetic fabrics, any type of foam, natural or synthetic rubber, natural or synthetic animal hide, silicone, plastic, or any other type of material;
an adhesive layer comprising a pressure sensitive adhesive;
a removable release liner;
a length from 2 inches to 7 inches;
a width from 2 to 7 inches;
a generally uniform thickness from 0.1 mm to 1.95 mm;
a single specific shape that would cover at least 75% of a specific laptop's wrist rest area, and would not exceed the boundary of the wrist rest area set by the trackpad to one side, the end of the laptop's surface at another side, the bottom edge, and the keyboard at the top edge,
wherein the apparatus' specific shape would be designed with respect to any laptop computer manufactured today, in the past, or will be manufactured in the future, from manufacturers including but not limited to Apple, Dell, HP, Lenovo, or any other laptop manufacturer.

2. The laptop surface enhancing apparatus of claim 1, wherein the surface layer has a texture with therapeutic benefit including but not limited to: bumps, ridges, grooves, or any other variation that will occur to those of skill in the art.

3. The laptop surface enhancing apparatus of claim 1 wherein at least one additional benefit layer exists between the surface layer and the adhesive layer, wherein the benefit layer provides an additional benefit to the user such as absorbing pressure, cooling the body, or any other benefit, and this benefit layer can be comprised of, but is not limited to, rubber, foam, cooling gel, fabric, plastic, animal hide, any other material, or any combination of materials.

4. The multi layered, surface enhancing apparatus of claim 3, wherein the surface layer has a texture with therapeutic benefit including but not limited to: bumps, ridges, grooves, or any other variation that will occur to those of skill in the art.

5. An apparatus for enhancing the surface of a laptop computer's wrist rest without removing the laptop computer's standard hardware, that uses multiple shapes together to tailor the coverage of the apparatus depending on the size of the user's laptop comprising:
a base shape;
wherein the base shape comprises a surface layer,
wherein the surface layer comprises of material that provides a different tactile feeling than the standard surface on the user's laptop computer and can, but does not need to be, decorated with artwork or color if desired,
wherein the surface layer can be comprised of, but is not limited to, natural fabrics, synthetic fabrics, any type of foam, natural or synthetic rubber, natural or synthetic animal hide, silicone, plastic, or any other type of material;
an adhesive layer comprising a pressure sensitive adhesive;
a removable release liner;
a length from 1.50 inches to 7.0 inches;
a width from 1.50 to 7.0 inches;
a generally uniform thickness from 0.1 mm to 1.95 mm;
a single specific shape that would cover at least 75% of a specific laptop's wrist rest area, and would not exceed the boundary of the wrist rest area set by the trackpad to one side, the end of the laptop's surface at another side, the bottom edge, and the keyboard at the top edge,
wherein the apparatus' specific shape would be designed with respect to any laptop computer manufactured today, in the past, or will be manufactured in the future, from manufacturers including but not limited to Apple, Dell, HP, Lenovo, or any other laptop manufacturer;
on the same release liner as the base shape exists one or more ancillary shapes,
wherein the ancillary shape comprises a surface layer,
wherein the surface layer comprises of material that provides a different tactile feeling than the standard surface on the user's laptop computer, the surface layer can be comprised of, but is not limited to, natural fabrics, synthetic fabrics, any type of foam, natural or synthetic rubber, natural or synthetic animal hide, silicone, plastic, or any other type of material;
an adhesive layer comprising a pressure sensitive adhesive;
a removable release liner;
a length from 0.1 inches to 6 inches;
a width from 0.1 to 6 inches;
a generally uniform thickness from 0.1 mm to 1.95 mm;
a side measurement that is similar to at least one side of the base shape, similar being defined as within 0.5 inches of a base shape's measurement.

6. The multi-shape, surface enhancing apparatus of claim 5, wherein the surface layer has a texture with therapeutic benefit including but not limited to: bumps, ridges, grooves, or any other variation that will occur to those of skill in the art.

7. The multi-shape, surface enhancing apparatus of claim 1 wherein at least one additional benefit layer exists between the surface layer and the adhesive layer, wherein the benefit layer provides an additional benefit to the user such as absorbing pressure, cooling the body, or any other benefit, and this benefit layer can be comprised of, but is not limited to, rubber, foam, cooling gel, fabric, plastic, animal hide, any other material, or any combination of materials.

8. The multi shape, multi layered, surface enhancing apparatus of claim 7, wherein the surface layer has a texture with therapeutic benefit including but not limited to: bumps, ridges, grooves, or any other variation that will occur to those of skill in the art.

9. A system comprising more than one apparatus for enhancing the surface of a laptop computer's wrist rest area, wherein at least two apparatus use a multi shape configuration that allows the user to tailor the coverage of the apparatus depending on the size of the user's laptop by using greater or fewer shapes together, and at least two of these multi shape configurations are different in size, this multi apparatus system comprises:
at least two multi shape apparatus
wherein the base shape comprises a surface layer,
wherein the surface layer comprises of material that provides a different tactile feeling than the standard surface on the user's laptop computer,
wherein the surface layer can be comprised of, but is not limited to, natural fabrics, synthetic fabrics, any type of foam, natural or synthetic rubber, natural or synthetic animal hide, silicone, plastic, or any other type of material;
an adhesive layer comprising a pressure sensitive adhesive;
a removable release liner;
a length from 1.50 inches to 7.0 inches;
a width from 1.50 to 7.0 inches;
a generally uniform thickness from 0.1 mm to 1.95 mm;
a single specific shape that would cover at least 75% of a specific laptop's wrist rest area, and would not exceed the boundary of the wrist rest area set by the trackpad to one side, the end of the laptop's surface at another side, the bottom edge, and the keyboard at the top edge,
wherein the apparatus' specific shape would be designed with respect to any laptop computer manufactured today, in the past, or will be manufactured in the future, from manufacturers including but not limited to Apple, Dell, HP, Lenovo, or any other laptop manufacturer;
on the same release liner as the base shape exists one or more ancillary shapes,
wherein the ancillary shape comprises a surface layer,
wherein the surface layer comprises of material that provides a different tactile feeling than the standard surface on the user's laptop computer, the surface layer can be comprised of, but is not limited to, natural fabrics, synthetic fabrics, any type of foam, natural or synthetic rubber, natural or synthetic animal hide, silicone, plastic, or any other type of material;
an adhesive layer comprising a pressure sensitive adhesive;
a removable release liner;
a length from 0.1 inches to 6 inches;
a width from 0.1 to 6 inches;
a generally uniform thickness from 0.1 mm to 1.95 mm;
a side measurement that is similar to at least one side of the base shape, similar being defined as within 0.5 inches of a base shape's measurement;
at least two multi shape apparatus are of different size within the system.

10. The multi size, multi apparatus system for enhancing the surface of multiple laptop sizes of claim 9, wherein the surface layer described has a texture with therapeutic benefit including but not limited to: bumps, ridges, grooves, or any other variation that will occur to those of skill in the art.

11. The multi size, multi apparatus system for enhancing the surface of multiple laptop sizes of claim 9, wherein at least one additional benefit layer exists between the surface layer and the adhesive layer, wherein the benefit layer provides an additional benefit to the user such as absorbing pressure, cooling the body, or any other benefit, and this benefit layer can be comprised of, but is not limited to, rubber, foam, cooling gel, fabric, plastic, animal hide, any other material, or any combination of materials.

12. The multi layer, multi size, multi apparatus system for enhancing the surface of multiple laptop sizes of claim 11, wherein the surface layer described has a texture with therapeutic benefit including but not limited to: bumps, ridges, grooves, or any other variation that will occur to those of skill in the art.

13. An apparatus for enhancing the surface of both of a laptop computer's wrist rests with a single shape, without removing the laptop computer's standard hardware comprising:
a surface layer, wherein the surface layer comprises of material that provides a different tactile feeling than the standard surface on the user's laptop computer and can, but does not need to be, decorated with artwork or colors if desired
wherein the surface layer can be comprised of, but is not limited to, natural fabrics, synthetic fabrics, any type of foam, natural or synthetic rubber, natural or synthetic animal hide, silicone, plastic, or any other type of material;
an adhesive layer comprising a pressure sensitive adhesive;
a removable release liner;
a length from 2 inches to 7 inches;
a width from 2 to 7 inches;
a generally uniform thickness from 0.1 mm to 1.95 mm;
a single specific shape that would cover at least 75% of both of a specific laptop's wrist rest areas, and would not exceed the boundary of the wrist rest area set by the trackpad to one side, the end of the laptop's surface at another side, the bottom edge, and the keyboard at the top edge,
wherein the single shaped apparatus can also cover an area outside of the wrist rest area as defined as the area between the trackpad and the keyboard, or between the trackpad and the lower edge of the laptop,
wherein the apparatus' specific shape would be designed with respect to any laptop computer manufactured today, in the past, or will be manufactured in the future, from manufacturers including but not limited to Apple, Dell, HP, Lenovo, or any other laptop manufacturer.

14. The single shape, multi wrist rest enhancing apparatus of claim 13, wherein the surface layer has a texture with therapeutic benefit including but not limited to: bumps, ridges, grooves, or any other variation that will occur to those of skill in the art.

15. The single shape, multi wrist rest enhancing apparatus of claim 13, wherein at least one additional benefit layer exists between the surface layer and the adhesive layer, wherein the benefit layer provides an additional benefit to the user such as absorbing pressure, cooling the body, or any other benefit, and this benefit layer can be comprised of, but is not limited to, rubber, foam, cooling gel, fabric, plastic, animal hide, any other material, or any combination of materials.

16. The multi layer, single shape, multi wrist rest enhancing apparatus of claim 15, wherein the surface layer described has a texture with therapeutic benefit including but not limited to: bumps, ridges, grooves, or any other variation that will occur to those of skill in the art.
